(19) United States
(12) Patent Application Publication
(10) Pub. No.: US 2019/0157683 A1
(43) Pub. Date: May 23, 2019

(54) POROUS CURRENT COLLECTOR WITH DENSE ELECTRIC CONNECTION TAB FOR A LEAKTIGHT ELECTROCHEMICAL SYSTEM

(71) Applicant: COMMISSARIAT A L'ENERGIE ATOMIQUE ET AUX ENERGIES ALTERNATIVES, Paris (FR)

(72) Inventors: Jérémie Salomon, Grenoble Cedex 09 (FR); Djamel Mourzagh, Grenoble Cedex 09 (FR); Sébastien Solan, Grenoble Cedex 09 (FR)

(21) Appl. No.: 16/196,009

(22) Filed: Nov. 20, 2018

(30) Foreign Application Priority Data
Nov. 21, 2017 (FR) 1761019

(51) Int. Cl. H01M 4/66; H01M 2/26; H01M 2/08; H01M 2/16; H01M 4/13; H01M 4/80; H01M 10/0525

(52) U.S. Cl. CPC H01M 4/663; H01M 2/26; H01M 2/08; H01M 10/0525; H01M 4/13; H01M 4/80; H01M 2/1673

(57) ABSTRACT

A leaktight electrochemical system, comprising a packaging, a porous electrically conductive substrate, forming a current collector and supporting, on at least one of its main faces, at least one continuous pattern of active material of an electrode, and at least one dense electrically conductive tab, connected to the substrate at at least one electrically conductive junction obtained by sewing using at least one electrically conductive thread, the tab supporting, on each of its main faces, at least one sealing tape sealed to the packaging to ensure the leaktight closure thereof.

The present application claims priority to and incorporates by reference the entire contents of French Patent Application No. 1761019 filed in France on Nov. 21, 2017.

### TECHNICAL FIELD

The present invention relates to the field of electrochemical systems comprising a packaging for ensuring the leaktightness of the core with respect to the exterior.

More particularly, they may be metal-ion electrochemical generators, which operate according to the principle of insertion or deinsertion, in other words intercalation-deintercalation, of metal ions in at least one electrode.

The invention more particularly relates to a lithium or lithium-ion electrochemical accumulator.

The invention relates in particular to the production of a porous current collector, in particular based on carbon fibers, with a metal outlet tab for a metal-ion electrochemical accumulator.

Although described in reference to a lithium-ion accumulator, the invention applies to any metal-ion electrochemical accumulator, i.e. also sodium-ion, magnesium-ion, aluminum-ion, etc.

### PRIOR ART

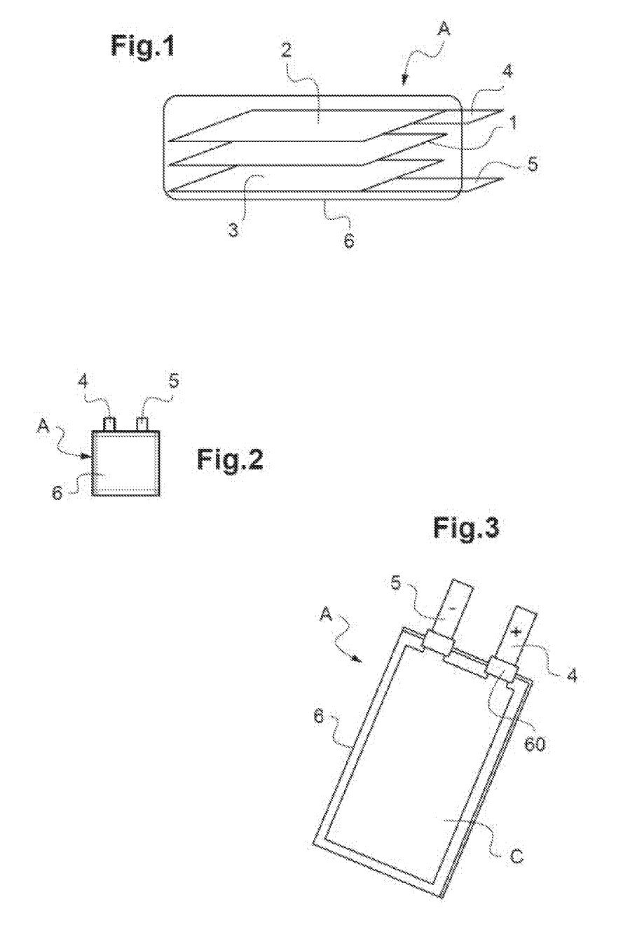

As illustrated schematically in FIGS. 1 and 2, a lithium-ion battery or accumulator usually includes at least one electrochemical cell C constituted of an electrolyte constituent 1, impregnated in a separator for electrically insulating the electrodes, between a positive electrode or cathode 2 and a negative electrode or anode 3, a current collector 4 connected to the cathode 2, a current collector 5 connected to the anode 3 and, finally, a packaging 6 arranged to contain the electrochemical cell and to render it leaktight to the external air and to the electrolyte inside the cell, while at the same time being traversed by a part of the current collectors 4, 5.

The architecture of conventional lithium-ion batteries is an architecture which may be termed as monopolar, since there is only one electrochemical cell including an anode, a cathode and an electrolyte. Several types of monopolar architecture geometry are known:
a cylindrical geometry, with winding around a cylindrical axis as disclosed in patent application US 2006/0121348,
a prismatic geometry, with winding around a parallelepipedal axis as disclosed in U.S. Pat. Nos. 7,348,098 and 7,338,733;
a stack geometry as disclosed in patent applications US 2008/060189, US 2008/0057392 and patent U.S. Pat. No. 7,335,448.

The electrolyte constituent may be of solid, liquid or gel form. In the latter form, the constituent may comprise a separator made of polymer or of microporous composite soaked with organic electrolyte(s) or of ionic liquid type which allows movement of the lithium ion from the cathode to the anode for charging and in the reverse anode for discharging, which generates the current. The electrolyte is generally a mixture of organic solvents, for example carbonates into which is added a lithium salt, typically LiPF6.

The positive electrode or cathode is constituted of lithium cation insertion materials which are generally composite, such as lithium iron phosphate LiFePO₄, lithium cobalt oxide LiCoO₂, lithium manganese oxide, optionally substituted, LiMn₂O₄ or transition metal oxide, for instance lamellar materials, a material based on LiNiₓMn_{y}Co_{z}O₂ with x+y+z=1, such as LiNi_{0.33}Mn_{0.33}CO_{0.33}O₂, or a base material of nickel cobalt aluminum oxide type LiNiₓCo_{y}Al_{z}O₂ with x+y+z=1, such as LiNi_{0.8}Co_{0.15}Al_{0.05}O₂.

The negative electrode or anode is very often constituted of carbon, graphite or Li₄TiO₅O₁₂ (titanate material), which is possibly silicon-based or lithium-based, or based on tin and alloys thereof or on a silicon-based formed composite. This negative electrode, just like the positive electrode, may also contain electron-conducting additives and also polymeric additives which give it mechanical properties and electrochemical performance qualities that are suitable for the lithium-ion battery application or for its implementation process.

The anode and the cathode made of lithium insertion material may be continuously deposited according to a usual technique in the form of an active layer on a metal sheet or foil constituting a current collector.

The current collector connected to the positive electrode is generally made of aluminum.

The current collector connected to the negative electrode is generally made of copper, nickel, nickel-copper or aluminum.

More precisely, aluminum is used for current collectors that are common to positive and negative electrodes of titanate Li₄Ti₅O₁₂. Copper is rather for the negative electrodes of graphite (Cgr), silicon (Si) or silicon composite (Si—C).

Conventionally, an Li-ion battery or accumulator uses a couple of materials at the anode and at the cathode, enabling it to function at a voltage level typically between 1.5 and 4.2 volts.

Depending on the type of application targeted, it is sought to produce either a thin and flexible lithium-ion accumulator or a rigid accumulator: the packaging is then either supple or rigid and in the latter case constitutes a kind of case.

The rigid packagings (cases) are usually manufactured from a metal material, typically an alloy of aluminum or of stainless steel or of a rigid polymer, for instance acrylonitrile-butadiene-styrene (ABS).

Supple packagings are usually manufactured from a multilayer composite material constituted of an aluminum foil covered with one or more roll-bonded polymer films. In the majority of these supple packagings, the polymer covering the aluminum is chosen from polyethylene (PE), propylene, polyamide (PA) or may be in the form of an adhesive layer constituted of polyester-polyurethane. The company Showa Denko markets composite materials of this type for use as battery packaging under the references NADR-0N25/AL40/CPP40 or No. ADR-0N25/AL40/CPP80.

FIG. 3 illustrates this type of supple packaging 6 which is arranged to insulate and render leaktight the electrochemical cell C while at the same time being traversed by a part 40, 50 of two strips or tabs 4, 5, forming the terminals and which extend in the plane of the electrochemical cell.

The main advantage of supple packagings is their lightness. Li-ion accumulators having the highest energy densities consequently include a supple packaging. The major drawback of these supple packagings is that their leaktightness may deteriorate greatly over time due to the lack of chemical resistance of the seal made.

A supple accumulator, commonly referred to as a Thin-Film Battery, is usually constituted of a single electrochemical cell.

The total thickness of the accumulator with its supple packaging is generally less than 0.6 mm, which enables it to be folded on a radius of curvature of between 20 and 30 mm, which depends on the dimensions and chemistry of the electrode materials, and this being possible without impairing the performance qualities during the functioning of the accumulator.

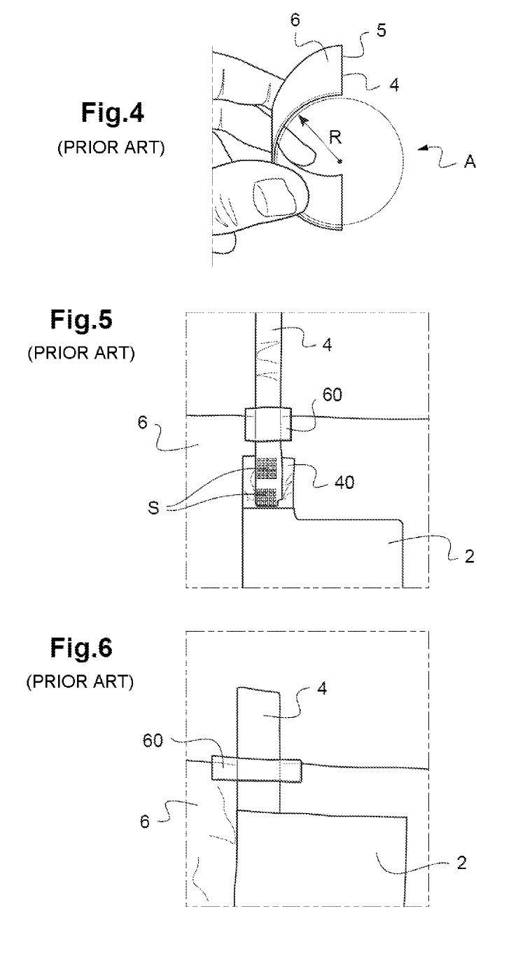

FIG. 4 represents such an accumulator A in a folded configuration, the radius of curvature R being symbolized.

To obtain optimum functioning of Li-ion accumulators, the electrochemical cell(s) must be leaktight with respect to atmospheric moisture. To ensure this leaktightness at the external connections of the accumulator, manufacturers use rivets or perform laser soldering in the case of a rigid packaging.

In the case of a supple packaging, a sealing tape is used. It is generally based on a hot-melt polymer around a metal outlet tab.

The tab may be sold as is and is dimensioned as a function of the passage of the current which is associated with the total capacity of the battery. For cells with a capacity of less than 2 Ah, the tab has a width of 5 mm and a thickness of 0.5 mm. The sealing tape is roll-bonded onto the tab and generally has a length of 10 mm, a width of 5 mm and a thickness of 0.3 mm. An example of such an aluminum tab 4 is shown in FIG. 5.

Thus, as shown in FIG. 3, polyolefin-based polymeric reinforcements 60 are provided to improve the hot sealing of the packaging 6 around the tabs 4, 5 and thus to ensure the leaktightness of the accumulator from the outside inward (water, oxygen, nitrogen, etc.) and vice versa (electrolyte, gases due to the electrochemical reactions, etc.).

Generally, the tabs added 4, 5 are attached to the substrates forming the current collectors of the electrodes via ultrasonic soldering. The tabs are generally made of nickel when they are attached to a copper collector and made of aluminum when they are attached to an aluminum collector.

An example of an aluminum tab 4 attached to an aluminum collector is shown in FIG. 5. A hot-melt polymer tape 60 is roll-bonded onto each main face of the tab 4.

Since the tabs with tape are initially provided in the form of a rolled-up continuous strip, the length is cut as required for the metal tab 4. When the accumulator comprises only one electrochemical cell, the outer connection may also be provided directly by the current collector substrates of the electrodes which are cut in a tab form.

In this case, a sealing tape which is sold separately from the tab is added to each main face of the current collector substrate, as represented in FIG. 6. This hot-melt polymer tape 60 generally has a width of 5 mm and a thickness of 0.1 mm. Since the tape is initially provided in the form of a rolled-up continuous strip, the length is cut as required for the current collector substrate.

As may be seen in FIGS. 5 and 6, the metal tab 4, typically made of aluminum, is either soldered to the current collector 40 by soldering parts S, or forms an integral part of the current collector 40.

Various attempts to replace the metal substrates of current collectors with carbon substrates and solutions for connecting these substrates with metal outlet tabs are found in the literature.

Mention may thus be made of U.S. Pat. No. 8,465,871 B2 which thus discloses the use of a carbon felt substrate and a method for connecting a metal outlet tab to the substrate by riveting.

Patent EP2619832B1 in the name of the Applicant discloses an electrode current collector for a lithium battery, which is porous and is made of woven or nonwoven carbon fibers.

Patent application WO2017/055705 in the name of the Applicant also describes a fixing process between a metal collector and a carbon felt which consists in impregnating the carbon felt with a mixture of a metal powder and in soldering between the metal collector and the impregnated carbon felt.

The proposed solutions are not entirely satisfactory. Specifically, firstly, the leaktightness obtained is not ensured and, secondly, these solutions do not make it possible genuinely to obtain an assembly of accumulators that is flexible enough to enable a battery resulting from this assembly to conform to any object.

There is thus a need to improve the electrodes of lithium accumulators, and more generally metal-ion accumulators, which are made from carbon-based current collector substrates, especially so as to increase the leaktightness of the accumulators while at the same time giving them suppleness properties for the purpose of ensuring conformability to a battery which results from an assembly of several of these accumulators.

The general aim of the invention is to at least partly meet this need.

### DESCRIPTION OF THE INVENTION

To do this, one subject of the invention is a leaktight electrochemical system, comprising:
a packaging;
a porous electrically conductive substrate, forming a current collector and supporting, on at least one of its main faces, at least one continuous pattern of active material of an electrode;
at least one dense electrically conductive tab, connected to the substrate at at least one electrically conductive junction obtained by sewing using at least one electrically conductive thread, the tab supporting on each of its main faces at least one sealing tape sealed to the packaging to ensure leaktight closure thereof.

The term “porous” means, herein and in the context of the invention, not leaktight with respect to air or to an electrolyte, especially via the edge of the substrate.

On the contrary, the term “dense” means, herein and in the context of the invention, leaktight with respect to air or to an electrolyte of the electrochemical system. The mass density of the tab is then equal to the theoretical density of the bulk material constituting it.

The term “electrically conductive” means, herein and in the context of the invention, a conductivity of greater than or equal to 1 S/cm.

The packaging of a system according to the invention may be rigid or supple.

Preferably, the tab is metallic, more preferably made of aluminum, copper or nickel. It has a thickness allowing this sewing preferably between 10 μm and 200 μm. However, any other dense and sufficiently conductive material may also be envisaged, such as certain sintered ceramics.

Preferably, the electrically conductive thread is made of copper or aluminum, or of carbon or is metalized, for instance metalized nylon. To ensure the mechanical strength of the assembly and also the passage of the current, a number of stitches of 16 points/cm² is preferably recommended.

A person skilled in the art will also dimension the various sections of passage of the current to ensure a maximum of 5 A/mm², so as to avoid heating.

Advantageously, the diameter of the thread is between 0.3 and 2 mm for a carbon thread, between 0.1 and 0.5 mm for a copper thread and between 0.8 and 2 mm for an aluminum thread.

The width of a sealing tape is preferably between 0.5 and 1 cm.

The thickness of a sealing tape is preferably between 0.05 and 0.2 mm.

More preferably, the sealing tape is based on hot-melt polymer. However, any other sealing material may also be envisaged, such as an adhesive, glass, on condition that it is compatible with the electrolyte of the electrochemical system.

According to an advantageous embodiment, the porous substrate is a substrate based on carbon fibers. It may advantageously be a nonwoven substrate. A metal foam, such as a nickel, copper, etc. foam, may also be envisaged as porous substrate.

According to this advantageous embodiment, the substrate based on carbon fibers is a nonwoven made from carbon fibers with a diameter preferentially between 2 and 20 μm, preferentially with a form factor between diameter and length of greater than 10, and preferably a density of between 1.8 and 2.2. The substrate made of carbon nonwoven preferably has a thickness of between 100 and 250 μm, preferably a mass per unit volume of between 30 and 1100 mg/cm³, preferably a porosity of between 50% and 98%.

According to this advantageous embodiment, the inventors chose to use a porous current collector based on carbon fibers, which has the following numerous advantages:
increased flexibility relative to conventional metal collectors in Li-ion batteries,
similar flexibility for the positive and negative electrodes since the same substrate based on carbon fibers may be used, i.e. with the same thickness and the same mechanical properties,
increased tear strength relative to a conventional metallic current collector,
increase in the energy density per unit mass relative to a conventional metallic current collector, the density of carbon being lower than that of copper or aluminum,
a very good electrochemical compatibility of carbon with the majority of the electrode insertion materials.

On the other hand, since the substrate based on carbon fibers is porous, by conserving external connections also made of a substrate based on carbon fibers in the form of a bare strip/tab emerging from the current collector, the inventors found that the leaktightness of an Li-ion accumulator was not ensured.

Thus, to improve this, the inventors considered using metallic external connections in the form of dense conductive tabs which are attached to the carbon substrate by sewing, to ensure the suppleness and giving them a polymer-based sealing tape in order to ensure the leaktightness of the closure of the packaging on these dense tabs and no longer on porous tabs based on carbon fibers.

That said, the connections between metallic tabs and carbon substrates proposed according to the prior art, as described in patent application WO 2017/055705 and patents U.S. Pat. No. 8,465,871B2 and EP2619832B1 had shortcomings in terms of mechanical strength, electrical conduction and flexibility of the junctions.

The inventors then astutely considered integrally attaching the metallic external connections with the collector substrate based on carbon fibers by sewing using a carbon thread and/or a metal thread, preferably made of Cu, Al, etc.

In particular, the sewing makes it possible firstly to have a good electrical contact for the conduction of current between the collector based on carbon fibers and a metallic external connection and secondly to reinforce the mechanical properties at this external connection.

As regards the actual manufacture of the electrode, the process may be performed as follows.

The preparation of the electrode ink (active insertion material) is performed by mixing the constituents, namely the active material, the polymeric binder and the electron conductor. The function of the polymeric binder, PVdF or a water-soluble polymer, is to provide the mechanical properties of the electrodes while at the same time ensuring good contact between the electrolyte and the grains of the material. The electron conductor, usually carbon black, itself improves the electron conductivity of the electrodes.

The electrode ink is then deposited on the carbon fiber current collector via a coating process which consists in pouring the ink on the collector, thus forming a continuous electrode strip.

Other deposition techniques also exist, such as printing, spraying, dispensing or the like which consists in depositing the ink in the form of patterns on the collector. Continuous electrode patterns are thus formed rather than a continuous strip.

The continuous electrode patterns are preferably made via a printing technique using the prepared ink, more preferably by screen printing on the current collector substrates made of carbon nonwoven. Other printing techniques may be used, such as flexography, photogravure, inkjet, aerosol jet printing, etc. An important advantage of printing techniques is the ability to manufacture patterns of varied cross section (square, rectangular, round or more complex) and thus makes it possible to acquire a certain degree of freedom regarding the design of the accumulator according to the invention.

Among the printing techniques, screen printing has the advantage of being able to deposit a larger amount of ink in a single pass, which makes it possible to obtain large basis weights and thus high capacities. Similarly, the production rates are high, compared with coating which is the conventional process used by industrial battery manufacturers, typically a printing rate of 20 to 25 m/s for screen printing compared with a rate of 10 to 15 m/s for coating.

Once the deposition of the continuous electrode pattern has been performed, it is dried. To do this, the solvent is evaporated off by passing the electrode through a continuous or static furnace in a ventilated oven.

The electrodes are next calendered and then cut according to the pattern desired in the application.

According to an advantageous embodiment, the system comprises at least two tabs assembled with the porous substrate, at least one of the two tabs being intended to serve as electrical connection with another electrochemical system to which the system incorporating the electrode is connected.

The subject of the invention is also a metal-ion electrochemical accumulator (A) constituted from a leaktight electrochemical system described previously, comprising a stack of the following elements:
at least one negative electrode;
at least one positive electrode;
at least one electrically insulating separating film incorporating an electrolyte, arranged in contact with the negative electrode pattern and the positive electrode pattern;
a packaging arranged to contain the negative and positive electrodes, and the separating film, with leaktightness while at the same time being traversed by a first and a second terminal of the accumulator each constituted by the conductive tab sewn to the porous substrate of the negative electrode and of the positive electrode, the sealing tapes of the negative and positive electrodes being heat-sealed to the packaging.

The accumulator may constitute an Li-ion accumulator, the electrode patterns being made of lithium insertion material.

As regards the production of the external connection, for each negative or positive electrode, a metal tab intended to form the external connection or terminal of an accumulator is attached. The attachment takes place by sewing using a carbon thread and/or a metal thread and/or a thread that is only metalized.

As specified, in order to ensure the leaktightness of the accumulator, irrespective of the form obtained for the terminals, a tape in the form of a hot-melt polymer layer preferably chosen from a polyethylene (PE) or a polypropylene (PP), is added between the packaging and the tabs around said tabs.

The packaging of an accumulator according to the invention is preferably constituted of a single supple bag. It may be manufactured from a multilayer composite material constituted of an aluminum foil covered with one or more roll-bonded polymer films. The polymer covering the aluminum may be chosen from polyethylene (PE), propylene, polyamide (PA) or may be in the form of an adhesive layer constituted of polyester-polyurethane. The company Showa Denko markets composite materials of this type for use as battery packaging under the references NADR-0N25/AL40/CPP40 or No. ADR-0N25/AL40/CPP80. Thus, the supple bag in accordance with the invention is advantageously based on an airtight aluminized multilayer film. In order to seal the supple bag by heat-sealing, three sides of the bag may first be heat-sealed while leaving the fourth side open for the activation of the accumulator by filling with the electrolyte, and, once this filling has been performed, the fourth side is then heat-sealed, the metal tabs passing through the sealing. The problem of the leaktightness of the packaging while electrical connections based on carbon fibers must emerge from this packaging may thus be appreciated.

The accumulator according to the invention may be an Li-ion accumulator, the electrode patterns being made of lithium insertion material.

The term “electrode made of lithium insertion material” means, herein and in the context of the invention, an electrode pattern including at least one lithium insertion material and at least one polymeric binder. Optionally, the electrode pattern may also comprise an electron conductor, for example carbon nanofibers, carbon fiber nanotubes or carbon black.

The term “lithium insertion material”, in particular for the positive electrode patterns, means, herein and in the context of the invention, a material chosen from lithiated oxides comprising manganese of spinel structure, lithiated oxides of lamellar structure and mixtures thereof, lithiated oxides with polyanionic frameworks of formula LiM_{y}(XO_{z})ₙ with M representing an element chosen from Mn, Fe, Co, Ni, Cu, Mg, Zn, V, Ca, Sr, Ba, Ti, Al, Si, B and Mo, X representing an element chosen from P, Si, Ge, S and As, y, z and n being positive integers.

The term “lithium insertion material”, in particular for the negative electrode patterns, also means a material chosen from: lithiated or non-lithiated titanium oxide, for example Li₄Ti₅O₁₂ or TiO₂, graphite, silicon, or silicon composite. More particularly, the material of the negative electrode patterns may be chosen from carbon-based materials, non-lithiated titanium oxides and derivatives thereof and lithiated titanium oxides such as Li₄Ti₅O₁₂ and derivatives thereof, and a mixture thereof.

The term “lithiated derivative” means, herein and in the context of the invention, compounds of formulae Li₍₄₋ₓ₁₎Mₓ₁Ti₅O₁₂ and Li₄Ti_{(5-y1)}N_{y1}O₁₂, in which x1 and y1 are, respectively, between 0 and 0.2 and M and N are, respectively, chemical elements chosen from Na, K, Mg, Nb, Al, Ni, Co, Zr, Cr, Mn, Fe, Cu, Zn, Si and Mo.

The term “non-lithiated derivative” means, herein and in the context of the invention, Ti_{(5-y1)}N_{y1}O₁₂, with y1 between 0 and 0.2 and N is a chemical element chosen from Na, K, Mg, Nb, Al, Ni, Co, Zr, Cr, Mn, Fe, Cu, Zn, Si and Mo.

Preferably, the anodes are made of graphite and the cathodes are made of LiNi_{0.8}Co_{0.15}Al_{0.05}O₂ (NCA).

The term “separator” means, herein and in the context of the invention, an electrically insulating ion conductor formed from at least one polymer material. The separator is preferably a monolayer or multilayer polymeric microporous film based on polyolefin PP and/or PE. Each separating film is cut according to the desired pattern via a mechanical process or by laser.

The separator may be implemented directly on the (positive or negative) electrode patterns by printing, preferably screen printing, using a polymer solution.

According to this variant, the separator may be chosen from the following polymers:
polyvinylidene fluoride (PVdF) or derivatives, polyvinyl acetate (PVA), polymethyl methacrylate (PMMA), polyoxyethylene (POE) or derivatives, polyethylene terephthalate (PET), polyacrylics or derivatives, polyolefins such as polypropylene, polyethylene, cellulose;
copolymers of the type such as PVdF-HFP (hexafluoropropylene), PVdF-PO, etc.;
cation-conducting ionomers or cation-conducting crystalline polymers;
heat-sensitive or photosensitive polymers which crosslink under the action of heat or of UV radiation,
UV-polymerizable or heat-polymerizable monomers, optionally bearing an ionic charge based on a lithium salt, for instance polyHIPE.

The polymer is dissolved in a solvent, or in a solvent/nonsolvent mixture in the case of a phase inversion process.

The polymer solution is deposited on the electrode patterns in the form of a thin layer and the solvent is then evaporated off by passing the electrode through a continuous or static furnace. Depending on the polymer and the implementation process used, the thin layer of electrolytic component may be porous, dense or gelled in the presence of the electrolyte. The thickness of the polymer layer is preferably between 5 and 40 μm.

Other separators may be envisaged as composites constituted of a polymer layer of very low thickness, of the order of 15 The polymer used may be PET or polyethylene terephthalate. This very thin polymer sheet may then be covered with ceramic grains made of alumina (Al₂O₃) and silica (SiO₂). Mention may be made here of the separator sold under the name Separion by the company Evonik.

Separators based on polymers reinforced with glass fibers for mechanical properties may also be envisaged. These separators are nonwoven since the glass fibers are only mixed together randomly.

Finally, ceramic separators especially including alumina, which has the advantage of having a retarding effect on thermal runaway, may be envisaged.

The electrolyte according to the invention may be a liquid formed by a mixture of carbonate and at least one lithium salt. The term “lithium salt” preferably means a salt chosen from LiPF₆, LiClO₄, LiBF₄ and LiAsF₆.

Alternatively, the electrolyte may comprise one or more ionic liquids, based on lithium ions, namely a salt constituted of lithium cations, complexed with inorganic or organic ions, which has the property of being in the liquid state at room temperature. Depending on the nature of the anion, an ionic liquid may be hydrophilic or hydrophobic. Examples of ionic liquids that may be mentioned include ionic liquids based on hydrophobic anions such as trifluoromethanesulfonate (CF₃SO₃), bis(trifluoromethanesulfonate imide [(CF₃SO₂)₂N] and tris(trifluoromethanesulfonate) methide [(CF₃SO₂)₃C].

Preferably, the surface area of each negative electrode pattern is greater than the surface area of each positive electrode pattern. This thus ensures that all the metal ions of the positive insertion material, such as the Li⁺ ions in a lithium accumulator, can migrate to the negative electrode and thus become intercalated in the structure. Besides the alignment of the positive electrode patterns with the negative electrode patterns, the surface area of the negative electrode patterns may also be increased compared with that of the positive electrode patterns. This may correspond to a strip of active material, added to each side of each negative electrode pattern. An added strip may typically have a width of 1 mm.

A subject of the invention is also a battery comprising a plurality of accumulators as above, two adjacent accumulators being connected together electrically via at least one electrical connecting strip made of porous conductive substrate, one end of which is connected to a dense tab of a negative or positive electrode of one of the two accumulators and the other end is connected to a dense tab of a negative or positive electrode, respectively, of the other of the two accumulators, the connection between the strip and each of the tabs being made according to at least one electrically conductive junction obtained by sewing using at least one metal and/or carbon thread.

According to an advantageous variant, two adjacent accumulators are connected together electrically parallel via two electrical connecting strips, one of which connects the positive electrodes of the two accumulators together and the other connects the negative electrodes of the two accumulators together.

Alternatively, two adjacent accumulators are connected together electrically in series via a single electrical connecting strip.

The battery may advantageously comprise at least one mechanical connecting strip made of porous conductive substrate, each of the ends of which is connected to a dense mechanical connection tab which is not connected to a negative or positive electrode of the accumulators, the connection between the mechanical connecting strip and each of the mechanical connection tabs being made according to at least one junction obtained by sewing using at least one thread.

Finally, a subject of the invention is a process for preparing a leaktight electrochemical system comprising the following steps:

a/ production of a continuous pattern of electrode active material on a porous electrically conductive substrate forming a current collector;

b/ production of at least one electrically conductive junction between at least one dense electrically conductive tab and the substrate, by sewing using at least one metal and/or carbon thread,

c/ production, on each of the main faces of the tab, of at least one sealing tape intended for leaktight closure of the packaging,

d/ sealing between the sealing tape and packaging.

The advantages of the architecture of an accumulator or battery according to the invention compared with electrode architectures with current collector substrate made of carbon according to the prior art are numerous, and among which mention may be made of:
better leaktightness since the closing of the supple packaging is performed on a dense material of the electrodes of the accumulator, namely the use of carbon-metal junctions containing a sealing tape,
better flexibility between several accumulators according to the invention connected together by means of the supple junctions, which allows the resulting battery to conform to any object of an intended application,
adaptability as desired of the metal-carbon junction, in particular by varying the diameter of the thread and/or the pattern of the sewing,
little or no loss of electric contact resistance at the metal-carbon junction relative to the current collector made of carbon,
the possibility of very good distribution of the stitches over the entire surface of the metal tab, so as to increase the electrical contact,
absence of a compromise to be made between mechanical strength and contact surface since no holes are created as for the riveting according to the prior art.

The applications targeted for the accumulator according to the invention are numerous.

The general use of the accumulator is for electrically powering any electronic device that is capable of deforming so as to be conformed with a location which has form and/or space constraints.

It may be for sensors or antennae of RFID (Radio Frequency Identification) type intended to be implanted housed in the driving compartment of a motor vehicle, or in the smallest available recess of the vehicle, for communicating information.

It may also be for portable devices such as cellphones, of curved shape or the like in which it appears imperative for the accumulator to marry the shape of the device, etc.

An accumulator according to the invention is also directed toward the flexible electronic field with applications such as sensors for intelligent clothing, screens of flexible type, electronic papers, etc. in which the final object is subjected to repeated deformation constraints.

### DETAILED DESCRIPTION

Other advantages and features will emerge more clearly on reading the detailed description, which is given for illustrative purposes with reference to the following figures, among which:

FIG. 1 is a schematic view in exploded perspective showing the various elements of a lithium-ion accumulator;

FIG. 2 is a front view showing a lithium-ion accumulator with its supple packaging according to the prior art,

FIG. 3 is a perspective view of a lithium-ion accumulator with its supple packaging according to the prior art;

FIG. 4 is a photographic view in perspective showing a lithium-ion accumulator with its supple packaging according to the prior art, in its maximum curved configuration;

FIG. 5 is a photographic view of an example of a metal tab, as it is intended to be soldered to a current collector of an electrode in order to form a lithium-ion accumulator terminal according to the prior art;

FIG. 6 is a photographic view of the external connection made by the current collector substrate of the positive electrode which is cut in a tab form so as to form a lithium-ion accumulator terminal according to the prior art;

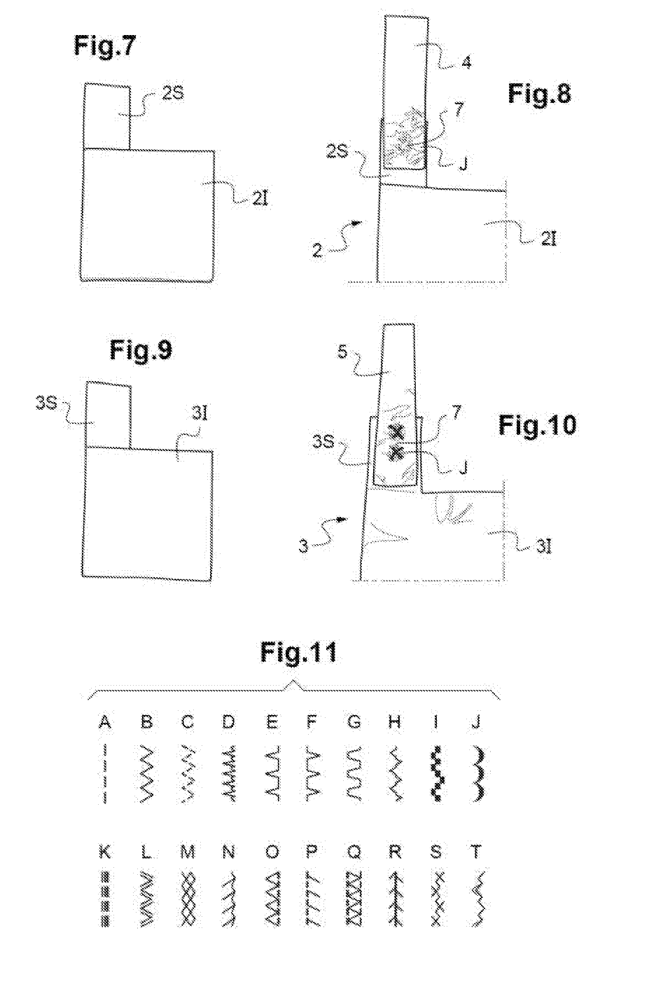

FIG. 7 is a photographic view of a positive electrode part according to the invention comprising a substrate based on carbon fibers supporting, on one of its main faces, a lithium positive insertion material pattern;

FIG. 8 is a photographic view of the positive electrode part of FIG. 7, the substrate of which has been connected by sewing to a metal tab intended to form a positive terminal of a lithium-ion accumulator;

FIG. 9 is a photographic view of a negative electrode part according to the invention comprising a substrate based on carbon fibers supporting, on one of its main faces, a lithium negative insertion material pattern;

FIG. 10 is a photographic view of the negative electrode part of FIG. 9, the substrate of which has been connected by sewing to a metal tab intended to form a negative terminal of a lithium-ion accumulator;

FIG. 11 symbolizes the various types of stitches A to T that may be envisaged in the context of making an electrically conductive junction between a metal tab and a substrate based on carbon fibers of an electrode according to the invention;

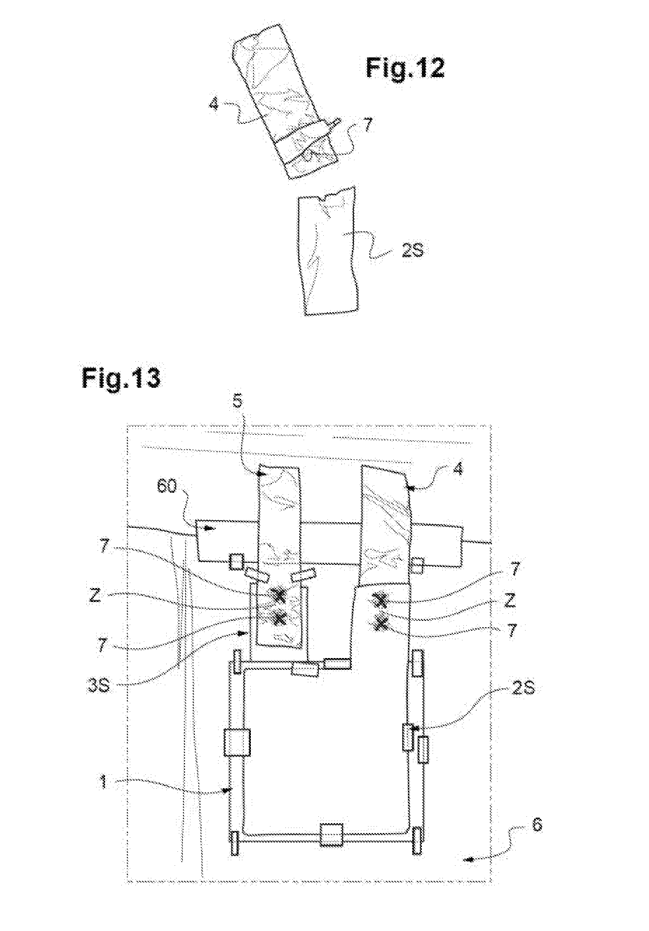

FIG. 12 is a photographic view of a substrate based on carbon fibers forming, with the metal tab, an electrode part according to the invention, the figure illustrating the rupture of the substrate after a tear test that it has undergone;

FIG. 13 is a photographic view showing the various constituents of an Li-ion accumulator according to the invention, including a positive electrode and a negative electrode according to the invention;

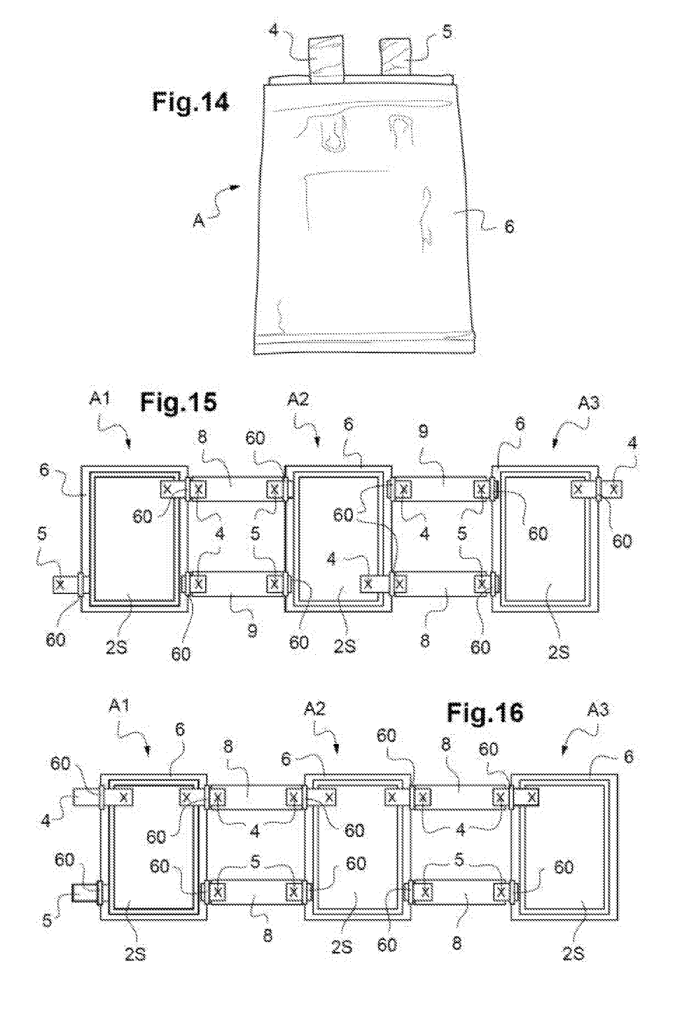

FIG. 14 is a photographic view showing the exterior of the accumulator according to FIG. 13, once finished;

FIG. 15 is a schematic view of a battery comprising three accumulators according to FIG. 14, connected together electrically in series;

FIG. 16 is a schematic view of a battery comprising three accumulators according to FIG. 14, connected together electrically in parallel.

For the sake of clarity, the same references denoting the same elements of an accumulator according to the prior art and of an accumulator according to the invention are used for all the FIGS. 1 to 16.

It is pointed out that the various elements according to the invention are represented solely for the sake of clarity, and that they are not to scale.

FIGS. 1 to 6 have already been commented on in the preamble. They will therefore not be detailed hereinbelow.

The invention is described below with reference to an exemplary embodiment of a positive electrode 2 according to the invention and of a negative electrode 3 according to the invention.

The positive electrode 2 first comprises a substrate based on carbon fibers 2S forming a current collector and supporting, on one of its main faces, a continuous pattern of metal ion positive insertion active material 2I (FIG. 7).

The negative electrode 3 also comprises a substrate based on carbon fibers 3S forming a current collector and supporting, on one of its main faces, a continuous pattern of metal ion negative insertion active material 3I (FIG. 9).

By way of example, the carbon fibers from which a substrate 2S or 3S is made may have a diameter of about 7 μm and a density of 2. A substrate 2S or 3S based on these carbon fibers may thus have a thickness of 150 μm, a mass per unit volume of 628 mg/cm³ and a porosity of 69%.

For each of these electrodes 2, 3 the electrode pattern is obtained by performing the four main steps 1/ to 4/ below.

Step 1/: Preparation of the electrode ink by mixing the constituents, namely the active material, the polymeric binder and the electron conductor. The polymeric binder, PVdF or a water-soluble polymer, has the function of providing the mechanical properties of the electrodes while at the same time ensuring good contact between the electrolyte and the grains of material. The electron conductor, usually carbon black, itself improves the electron conductivity of the electrodes.

Step 2/: The implementation of the electrode is performed by coating. The ink obtained in step 1/is poured onto the current collector substrate based on carbon fibers, which thus forms a continuous electrode strip. Printing of the ink may also be performed for deposition in the form of patterns on the substrate based on carbon fibers. The pattern may be of simple geometrical form such as a square, rectangle or circle, but may also be more complex (calligraphy, etc.).

Step 3/: Once the ink has been deposited on the substrate based on carbon fibers, it is dried. The solvent is then evaporated off by passing the electrode through a continuous or static furnace in a ventilated oven.

Step 4/: The electrodes are then calendered and then cut according to the continuous pattern targeted by the application.

In the example illustrated, the positive electrode 2 comprises as active material LiNiCoAlO₂, denoted as NCA (FIG. 7) and the negative electrode 3 is based on graphite (FIG. 9).

Junctions of a metal tab 4, 5 with the substrate based on carbon fibers 2S, 3S or, respectively, with the positive electrode 2 and the negative electrode 3, are then made.

In the example illustrated, to make these carbon-metal junctions, an aluminum tab 4, of thickness 20 μm, for the positive electrode NCA 2 and a copper tab 5, of thickness 10 μm, for the graphite negative electrode 3, are used.

These metal tabs 4, 5 were attached to the collector substrate based on carbon fibers 2S, 3S via stitches made manually using a needle and carbon thread 7, of diameter 1 mm. The sewing may use the standard techniques for the sewing machine assembly of metal threads. As regards the finishing knots of the sewing, once the tab/C felt junction has been made, a standard technique may be used for stopping the sewing, for example sewing in reverse at virtually the same place.

The carbon-metal junctions J obtained by sewing with the thread 7 are shown, respectively, in:
FIG. 8, for the positive electrode NCA 2 finished with its aluminum tab 4;
FIG. 10, for the graphite negative electrode 3 finished with its copper tab 5.

To make the junctions J with one or more threads 7 made of carbon or metal, it may be envisaged to make the stitches at the industrial scale with sewing machines. The patterns of the points may be diverse and varied, for instance straight-line sewing, zig-zag sewing, etc.

FIG. 11 shows various patterns A to T of stitch patterns that may be envisaged.

In order to check the mechanical strength of these stitches, the inventors performed a manual tear test. The result of this test for an aluminum-carbon junction of a positive electrode 2 is shown in FIG. 12. This result is satisfactory since, as emerges from this FIG. 12, it is the collector substrate based on carbon fibers 2S which tears and not the stitch 7. Once the positive electrode NCA 2 and the graphite negative electrode 3 according to the invention have been finished with their junctions J with metal tabs 4, 5, the accumulator A is made as usual by stacking.

Thus, a film 1 of electrically insulating separator, of polymeric microporous type, is arranged in contact with each of the electrode patterns 2I, 3I supported, respectively, by the substrate based on carbon fibers 2S and the substrate based on carbon fibers 3S.

A sealing tape 60 based on hot-melt polymer is then placed on either side of the aluminum 4 and copper 5 metal tabs.

A supple packaging 6, which is leaktight with respect to the electrolyte and to air, is arranged to contain the positive electrode 2 and the negative electrode 3 and the microporous separating film 1, with leaktightness while at the same time being traversed by the tabs 4, 5 forming the terminals of the accumulator.

The assembly of these various elements is shown in FIG. 13.

In this illustrated example, the supple packaging 6 is constituted of a multilayer film which is aluminized on the exterior.

Closure of the supple packaging 6 is then performed.

Three sides of the packaging 6 are thus heat-sealed and the fourth side is kept open to be able to activate the accumulator, which consists in filling the interior of the packaging container thus formed with electrolyte. After activating the accumulator, this fourth side is also heat-sealed.

The accumulator A according to the invention thus prepared and finalized is shown in FIG. 14.

Depending on the desired final application and/or voltage, a plurality of accumulators according to the invention may be assembled together in electrical series or parallel so as to constitute a final battery.

FIG. 15 shows an example of an assembly in series of three identical accumulators A1, A2, A3 obtained according to the example described previously.

As emerges from this FIG. 15, the final battery comprises two outlet terminals or connections at the ends, one 5 connected to the negative electrode 3 on one of the end accumulators A1 and the other 4 connected to the positive electrode 2 on the other of the end accumulators A3.

The accumulators A1, A2, A3 are connected together electrically via the metal tabs/terminals 4, 5 which are sewn or woven onto the substrates made of carbon nonwoven 2S, 3S and also via electrical connecting strips 8 also based on carbon fibers. One of the ends of a strip 8 is connected to a positive metal tab 4 and the other of the ends of the strip 8 is connected to a negative metal tab 5. These connections are also made via carbon-metal junctions J by sewing with a carbon or metal thread 7 as explained hereinabove.

In order to conserve good articulation and to mechanically reinforce the structure, a mechanical connecting strip 9 is advantageously added between two adjacent accumulators A1-A2, A2-A3.

Each mechanical connecting strip 9 is based on carbon fibers, each of the ends of which is connected to a metal tab 4, 5 also via a metal-carbon junction J. Each strip 9 is arranged parallel to an electrical connecting strip 8 connecting the two terminals, positive 4 and negative 5.

The points of attachment of a mechanical connecting strip 9 to the supple packaging 6 of two adjacent accumulators A1-A2, A2-A3 are each constituted by a sealing tape 60 supported on either side of a metal tab 4, 5 as previously.

FIG. 16 shows an example of an assembly in electrical parallel of three identical accumulators A1, A2, A3 obtained according to the example described previously.

As emerges from this FIG. 16, the final battery comprises two outlet terminals or connections at the ends, one 5 connected to the negative electrode 3 on one of the end accumulators A1 and the other 4 connected to the positive electrode 2 on the same end accumulator A1.

In this instance, two adjacent accumulators A1-A2, A2-A3 are electrically connected via two electrical connecting strips 8 based on carbon fibers.

One of these two strips 8 connects together the positive electrodes 2 of the two accumulators A1-A2, A2-A3 and the other 8 connects together the negative electrodes 3 of the two accumulators A1-A2, A2-A3.

Other variants and advantages of the invention may be made without, however, departing from the scope of the invention.

The invention is not limited to the examples that have just been described; it is in particular possible to combine together characteristics of illustrated examples in variants that are not illustrated.

The expression “including a” or “comprising a” should be understood as being synonymous with “including at least one”, unless specifically mentioned otherwise.

1. A leaktight electrochemical system, comprising:
a packaging;
a porous electrically conductive substrate, forming a current collector and supporting, on at least one of its main faces, at least one continuous pattern of active material of an electrode; the electrically conductive porous substrate being based on carbon fibers;
at least one dense electrically conductive tab, connected to the substrate at at least one electrically conductive junction obtained by sewing using at least one electrically conductive thread, the tab supporting, on each of its main faces, at least one sealing tape sealed to the packaging to ensure the leaktight closure thereof.

2. The system according to claim 1, wherein the thread is metallic, or of carbon or only metalized.

3. The system according to claim 1, wherein the thickness of the tab is between 10 and 200 μm.

4. The system according to claim 1, wherein the number of stitches is at least equal to 16 stitches/cm².

5. The system according to claim 1, wherein the tab is metallic.

6. The system according to claim 1, wherein the metal thread is made of copper or aluminum.

7. The system according to claim 1, wherein the diameter of the thread is between 0.3 and 2 mm for a carbon thread, between 0.1 and 0.5 mm for a copper thread and between 0.8 and 2 mm for an aluminum thread.

8. The system according to claim 1, wherein the width of a sealing tape is between 0.5 and 1 cm.

9. The system according to claim 1, wherein the thickness of a sealing tape is between 0.05 and 0.2 mm.

10. The system according to claim 1, comprising at least two tabs assembled to the porous substrate, at least one of the two tabs being intended to serve as electrical connection with another electrochemical system to which the system incorporating the electrode is connected.

11. A metal-ion electrochemical accumulator (A) constituted from a leaktight electrochemical system according to claim 1, comprising a stack of the following elements:
at least one negative electrode;
at least one positive electrode;
at least one electrically insulating separating film incorporating an electrolyte, arranged in contact with the negative electrode pattern and the positive electrode pattern;
a packaging arranged to contain the negative and positive electrodes, and the separating film, with leaktightness while at the same time being traversed by a first and a second terminal of the accumulator, each constituted by the conductive tab sewn to the porous substrate of the negative electrode and of the positive electrode, the sealing tapes of the negative and positive electrodes being heat-sealed to the packaging.

12. The accumulator according to claim 11, constituting a Li-ion accumulator, the electrode patterns being made of lithium insertion material.

13. A Battery comprising a plurality of accumulators according to claim 11, wherein two adjacent accumulators are connected together electrically via at least one electrical connecting strip made of porous conductive substrate, one end of which is connected to a dense tab of a negative or positive electrode of one of the two accumulators and the other end is connected to a dense tab of a negative or positive electrode, respectively, of the other of the two accumulators, the connection between the strip and each of the tabs being made at at least one electrically conductive junction obtained by sewing using at least one metal and/or carbon thread.

14. The battery according to claim 13, wherein two adjacent accumulators are connected together electrically in parallel via two electrical connecting strips, one of which connects together the positive electrodes of the two accumulators and the other connects together the negative electrodes of the two accumulators.

15. The battery according to claim 13, wherein two adjacent accumulators are connected together electrically in series via a single electrical connecting strip.

16. The battery according to claim 15, also comprising at least one mechanical connecting strip made of porous conductive substrate, each of the ends of which is connected to a dense mechanical connection tab which is not connected to a negative or positive electrode of the accumulators, the connection between the mechanical connecting strip and each of the mechanical connection tabs being made at at least one junction obtained by sewing using at least one thread.

17. A process for preparing a leaktight electrochemical system comprising the following steps:
a/ producing a continuous pattern of electrode active material on a porous electrically conductive substrate forming a current collector; the porous electrically conductive substrate being based on carbon fibers;
b/ making at least one electrically conductive junction between at least one dense electrically conductive tab and the substrate, by sewing using at least one electrically conductive thread,
c/ producing, on each of the main faces of the tab, at least one sealing tape intended for leaktight closure of the packaging,
d/ sealing between the sealing tape and the packaging.
